(19) United States
(12) Patent Application Publication
(10) Pub. No.: US 2025/0197209 A1
(43) Pub. Date: Jun. 19, 2025

(54) APPARATUS AND METHOD FOR HYDROGEN GENERATION

(71) Applicant: PlasMerica, LLC, Miami, OK (US)

(72) Inventors: Dennis Keith Manning, Miami, OK (US); John C. Frisbie, Miami, OK (US); Jerrold J. Pellizzon, Miami, OK (US)

(21) Appl. No.: 18/866,967

(22) PCT Filed: May 18, 2023
(86) PCT No.: PCT/US2023/067199

§ 371 Date: Nov. 18, 2024

Related U.S. Application Data
(60) Provisional application No. 63/344,457, filed on May 20, 2022.

(51) Int. Cl. C01B 3/24

(52) U.S. Cl. CPC C01B 3/24; C01B 2203/0272; C01B 2203/0861; C01B 2203/1241

(57) ABSTRACT

A device for generating hydrogen may include a reaction vessel comprising: at least one grounded surface or electrode, a fluid inlet configured to allow a fluid feed stream to enter the reaction vessel, a fluid outlet configured to allow a fluid product stream to exit the reaction vessel, at least one high voltage electrode disposed within the reaction vessel, the at least one high voltage electrode separated from the at least one grounded surface or electrode by a plasma zone of the reaction vessel; and at least one dielectric insulator disposed with the reaction vessel such that the at least one dielectric insulator is disposed between the at least one grounded surface or electrode and the at least one high voltage electrode.

### BACKGROUND

### Field

The field relates to apparatuses and methods for hydrogen generation.

### Description of the Related Art

Hydrogen is a highly sought-after compound. However, many methods for generating hydrogen also produce carbon dioxide, thus increasing carbon emissions. There is a need to generate hydrogen which minimizes or eliminates production of carbon dioxide or other compounds related to carbon emissions.

### SUMMARY

In one aspect described herein, a device for generating hydrogen, comprises a shell; at least one grounded surface or electrode; a fluid inlet in fluid communication with the shell; a fluid outlet in fluid communication with the shell; at least one dielectric insulator disposed with the shell in contact with the at least one grounded surface or electrode; and at least one high voltage electrode disposed within the shell, the at least one high voltage electrode separated from the at least one dielectric insulator by a plasma zone.

In some embodiments, the at least one dielectric insulator is disposed within the shell such that it contacts the at least one grounded surface or electrode.

In some embodiments, the plasma zone is formed between the at least one high voltage electrode and the at least one dielectric insulator.

In some embodiments, the device further comprises a power supplier electrically connected to the at least one high voltage electrode, the power supplier configured to supply power to the at least one high voltage electrode in a form of an application voltage between 30,000 VAC and 50,000 VAC.

In some embodiments, the at least one grounded surface or electrode forms the shell.

In some embodiments, the at least one grounded surface or electrode is disposed on an inner surface of the shell.

In some embodiments, the at least one dielectric insulator is disposed on an inner surface of the at least one grounded surface or electrode.

In some embodiments, the at least one high voltage electrode is configured to generate a high voltage electric field within the plasma zone.

In some embodiments, the shell is cylindrical in shape.

In some embodiments, the at least one high voltage electrode and the at least one dielectric insulator are disposed concentrically or coaxially within the shell.

In some embodiments, the shell is a rectangular prism and wherein the at least one high voltage electrode is a plate electrode.

In some embodiments, the device further comprises a plurality of high voltage electrodes and a plurality of dielectric insulators arranged parallel to each other within the shell.

In another aspect described herein, a method for generating hydrogen, comprises providing a feed fluid to a reaction vessel via a fluid inlet, wherein the reaction vessel comprises: a shell; a grounded electrode disposed proximate the shell; a dielectric insulator in contact with the grounded electrode; a high voltage electrode disposed in the shell such that the high voltage electrode is separated from the grounded electrode by a plasma zone of the reaction vessel; and generating an electric field within the plasma zone of the reaction vessel; disassociating components of the feed fluid due to the electric field; and extracting one or more components of interest from the reaction vessel, via a fluid outlet of the reaction vessel.

In some embodiments, generating an electric field comprises supplying power to the high voltage electrode, wherein the power supplied is in a form of an application voltage between 30,000 VAC and 50,000 VAC.

In some embodiments, supplying power to the high voltage electrode is accomplished via a power supplier connected electrically to the high voltage electrode.

In some embodiments, disassociating the feed fluid comprises exposing the hydrocarbons to the electric field generated in the plasma zone.

In some embodiments, the method further comprises adjusting a retention time of the feed fluid within the reaction vessel such that feed fluid remains in the reaction vessel for between 30 seconds and 5 minutes.

In some embodiments, wherein the feed fluid is compressed natural gas (CNG).

In some embodiments, the feed fluid comprises hydrocarbon components, and wherein disassociating the components of the feed fluid comprises disassociating the hydrocarbon components into hydrogen and carbon.

In some embodiments, extracting the component of interest comprises extracting hydrogen from the reaction vessel.

### BRIEF DESCRIPTION OF THE DRAWINGS

The detailed description is set forth with reference to the accompanying figures. The use of the same numbers in different figures indicates similar or identical items.

For this discussion, the devices and systems illustrated in the figures are shown as having a multiplicity of components. Various implementations of devices and/or systems, as described herein, may include fewer components, and remain within the scope of the disclosure. Alternatively, other implementations of devices and/or systems may include additional components, or various combinations of the described components, and remain within the scope of the disclosure.

FIG. 1A is a front cross-sectional view of a device for generating hydrogen from a hydrocarbon.

FIG. 1B is a top cross-sectional view of a device for generating hydrogen from a hydrocarbon.

FIG. 2 is a cross-sectional view of a single electrode device for generating hydrogen from a hydrocarbon.

FIG. 3 is a cross-sectional view of a multiple electrode device for generating hydrogen from a hydrocarbon.

FIG. 4 is a cross-sectional view of a multiple electrode concentric configuration of a device for generating hydrogen from a hydrocarbon.

FIG. 5 is a cross-sectional view of a multiple electrode configuration of a device for generating hydrogen from a hydrocarbon.

FIG. 6 is an illustration of a high voltage electrode of a device for generating hydrogen from a hydrocarbon following experimental testing.

FIG. 7 is an illustration of a high voltage electrode of a device for generating hydrogen from a hydrocarbon following experimental testing.

FIG. 8A is an illustration of a dielectric insulator of a device for generating hydrogen from a hydrocarbon following experimental testing.

FIG. 8B is an image of a dielectric insulator of a device for generating hydrogen from a hydrocarbon following experimental testing.

FIG. 9A is a gas chromatogram of an exit gas from a device for generating hydrogen from a hydrocarbon taken without operation of the device.

FIG. 9B is a gas chromatogram of an exit gas from a device for generating hydrogen from a hydrocarbon taken after operation of the device.

FIG. 10A is a gas chromatogram of an exit gas from a device for generating hydrogen from a hydrocarbon taken without operation of the device.

FIG. 10B is a gas chromatogram of an exit gas from a device for generating hydrogen from a hydrocarbon taken after operation of the device.

### DETAILED DESCRIPTION

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following detailed description is directed to certain specific embodiments of the development. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Furthermore, embodiments of the development may include several novel features, no single one of which is solely responsible for its desirable attributes or which is essential to practicing the invention described herein.

One currently utilized hydrogen generation process is the cracking of methane using high temperature, high pressure steam. This process results in one mole of carbon dioxide formed for every mole of hydrogen. Some embodiments described herein provide hydrogen generation without coproduction of carbon dioxide or without carbon dioxide in the product stream. The embodiments provided herein can provide reduced carbon emissions and/or carbon footprints compared to current technologies.

Some embodiments disclosed herein relate generally to a device for generating hydrogen from a gas phase hydrocarbon. In some embodiments, the device can cause hydrocarbon destruction (which also may be referred to as disassociation) into hydrogen and carbon. The device may be in the form of a reactor vessel.

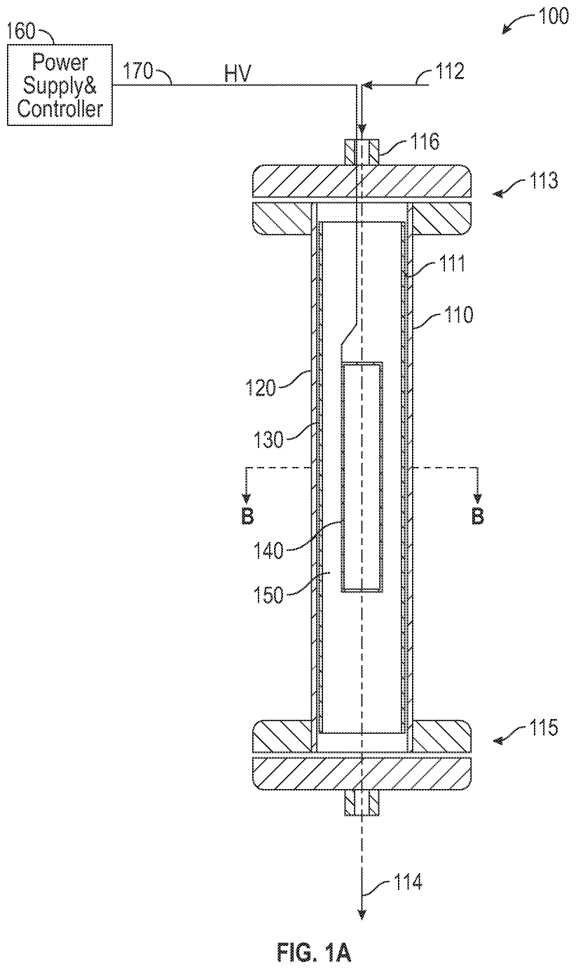

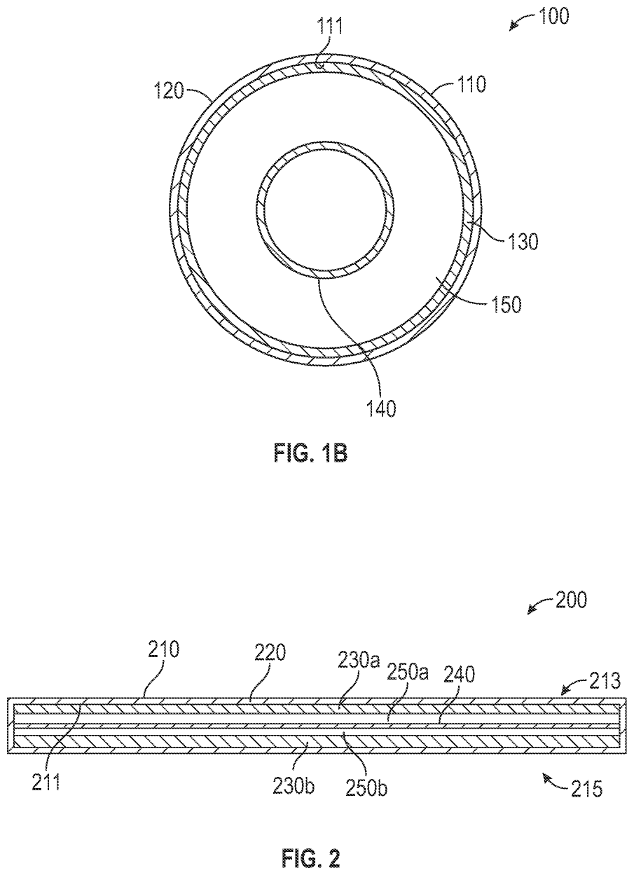

FIG. 1A is a front cross-sectional view of a device 100 for generating hydrogen from a hydrocarbon. FIG. 1B is a top cross-sectional view taken along the line B-B of the device 100. For clarity reasons, FIG. 1B does not show components that would otherwise be visible at a second end 115 of a shell 110. The device 100 comprises a shell 110, a grounded surface or electrode 120, a dielectric insulator 130, a high voltage electrode 140, a plasma zone 150 and a power supply/controller 160.

As seen in FIGS. 1A and 1B, the shell 110 is substantially cylindrical in shape. The shell 110 comprises a fluid inlet 112, a fluid outlet, 114 and a high voltage entrance device 116. The fluid inlet 112 is positioned at a first end 113 of the shell 110. A fluid enters the fluid inlet 112 and flows into the reaction vessel 100. In some embodiments, the diameter of the fluid inlet 112 may be increased or decreased to alter the flow rate of a fluid feed stream entering the shell 110. In some embodiments, the flow rate may be adjusted to alter retention times of the fluid within the shell 110. In some embodiments, the fluid feed stream may comprise hydrocarbons.

As shown in FIG. 1A, the fluid outlet 114 is positioned at a second end 115 of the shell 110. A fluid flows from the device 100 out through the fluid outlet 114. In some embodiments, the diameter of the fluid outlet 114 may be increased or decreased to alter the flow rate of a fluid product stream exiting the device 100. In some embodiments, the flow rate may be adjusted to alter retention times of the fluid within the device 100. In some embodiments, the fluid product stream may comprise hydrogen. In some embodiments, the device 100 can be a U-shaped reactor+.

As seen in FIGS. 1A and 1B, the grounded surface or electrode 120 forms the shell 110. In some embodiments, the grounded surface or electrode 120 may be formed on an inner surface 111 of the shell 110. In some embodiments, the grounded surface or electrode 120 may be formed on the inner surface 111 of the shell such that the grounded electrode 120 spans the entire inner surface 111 of the shell 110. In some embodiments, the grounded surface or electrode 120 may only cover a portion of the inner surface 111 of the shell 110. In some embodiments, the grounded surface or electrode 120 may be annular in shape.

As seen in FIG. 1B, the dielectric insulator 130 is disposed concentrically or coaxially within the shell 110. In some embodiments, the dielectric insulator 130 may formed on or contact the grounded surface or electrode 120. In some embodiments, the dielectric insulator 130 may cover the entire grounded surface or electrode 120. In some embodiments, the dielectric insulator 130 may only cover a portion of the grounded surface or electrode 120. The dielectric insulator 130 acts as an electric insulator for an electric field generated by the high voltage electrode 140. As seen in FIGS. 1A and 1B, the dielectric insulator 130 acts as an electrical barrier between the high voltage electrode 140 and the grounded surface or electrode 120, thereby preventing or reducing current flow between the grounded surface or electrode 120 and the high voltage electrode 140.

In some embodiments, the dielectric insulator 130 may be composed of quartz, glass, ceramics, polymers or other suitable dielectrics. In some embodiments, the dielectric insulator 130 may be composed of a mixture or combination of the materials described above or other suitable materials.

As seen in FIG. 1B, the high voltage electrode 140 is substantially cylindrical in shape. The high voltage electrode 140 is disposed concentrically or coaxially within the shell 110 and is separated from the dielectric insulator 130 by a plasma zone 150. In some embodiments, the plasma zone 150 is a space or a void in the device 100 that is filled with feed fluid when in operation. In some embodiments, the high voltage electrode 140 can be a rod or a cylinder, such as a hollow cylinder. As seen in FIG. 1A, the high voltage electrode 140 only extends along a portion of the shell 110. In some embodiments, the high voltage electrode 140 may span the length of the shell 110.

Power is supplied to the high voltage electrode 140 to generate a high voltage electric field within the plasma zone 150 of the shell 110. In some embodiments, power can be supplied to the electrode 140 in the form of an application voltage of between 100 VAC and 100,000 VAC, between 100 VAC and 10,000 VAC, between 500 VAC and 1,500 VAC, about 500 VAC, about 1,000 VAC, about 5,000 VAC, about 10,000 VAC, about 45,000 VAC, about 50,000 VAC, or any other suitable application voltage. In some embodiments, the electric field generated by the high voltage electrode 140 causes the disassociation of hydrocarbons passing through the plasma zone 150 of the shell 110.

Power supplied to the high voltage electrode 140 can be alternating current in various wave forms, ranging in voltage from 100 VAC to 10,000 VAC and frequencies from 60 Hz to 10,000 Hz. In some embodiments, power supplied to the high voltage electrode 140 can be direct current or pulsed direct current fields. In some embodiments, power supplied to the high voltage electrode 140 can be any combination of alternating current, direct current, and pulsed direct current fields.

The power supply/controller 160 is electrically coupled to the high voltage electrode 140. The power supply/controller 160 supplies power to the high voltage electrode 140 to generate an electric field in the plasma zone 150. The dielectric insulator 130 acts as an electric insulator for the high voltage electric field. The dielectric insulator 130 acts as a barrier between the high voltage electrode 140 and the grounded surface or electrode 120. The dielectric insulator 130 acting as a barrier between the high voltage electrode 140 and the grounded surface or reference electrode 120 can enable, enhance, and/or increase the destruction of hydrocarbons in a feed fluid.

In some embodiments, the power supply/controller 160 is coupled to the high voltage electrode 140, for example, via a high voltage cable 170. In some embodiments, the high voltage cable 170 can extend between the power supply/controller 160 and the electrode 140 through the fluid inlet 112. In some embodiments, the device 100 can include a high voltage entrance device 116. The high voltage entrance device 116 may be a high voltage insulator entrance bushing.

In operation of the device 100, a fluid feed stream flows from an upstream position through the fluid inlet 112 into the shell 110 of the reactor. In some embodiments, the fluid feed stream comprises hydrocarbons. In some embodiments, the fluid feed stream comprises methane, ethane, ethene, propane, propene, isobutane, butane, acetylene or a mixture or combination of these compounds. In some embodiments, the fluid feed stream comprises compressed natural gas (CNG). In some embodiments, the fluid feed stream advantageously is not preheated prior to entering the shell 110. Not preheating the fluid feed stream can greatly reduce the energy requirements of a hydrogen generation reaction compared to a traditional steam reformation process.

Upon entering the shell, the fluid feed stream flows through the plasma zone 150 of the shell 110. As the fluid feed stream flows through the plasma zone 150 of the shell 110, it is subjected to the electric field generated between the high voltage electrode 140 and the grounded surface or electrode 120. The electric field causes the fluid feed stream to react. Upon reacting, the fluid product stream exits the plasma zone 150 of the shell 110 through the fluid outlet 114. In some embodiments, the fluid product stream is not subject to downstream cooling. In some embodiments, downstream separation may be used to obtain a desired chemical purity within the product stream.

The techniques and devices described herein are beneficial for disassociating or destroying hydrocarbons and the production of a hydrogen product stream. Destruction of hydrocarbons can include lysis of hydrocarbon compounds, breaking of chemical bonds, reducing the molecular weight of hydrocarbon components. In some embodiments, hydrogen is generated by subjecting a fluid feed stream comprising hydrocarbons, for example, methane, natural gas, or the like to an electric field in the plasma zone 150. In some embodiments, the fluid feed stream advantageously does not comprise oxygen or any compounds containing oxygen thereby preventing the formation of carbon dioxide. The dielectric insulator 130 acts as an electric barrier between the grounded surface or electrode 120. In this configuration, the dielectric insulator 130 does not act as a propagation point for the hydrocarbons in the fluid feed stream, thereby promoting a disassociation reaction over a propagation reaction. Upon being subjected to the electric field, the hydrocarbons in the plasma zone 150 disassociate to forming primarily hydrogen and elemental carbon. The elemental carbon forms on the dielectric insulator 130 and/or on the high voltage electrode 140.

The device 100 can operate at low, moderate, or high pressures depending on the application demand. In some embodiments, the pressure can be between 1 psig and 10 psig. In some embodiments, the pressure can be 2 psig. The pressure may be related to the amount of hydrocarbon destruction. For example, in some embodiments, greater pressures may lead to greater amounts of hydrocarbon destruction. In some embodiments, increasing pressure may force the molecules of the feed gas into closer proximity and increase gas conductivity. This may improve energy transfer through the gas phase. In some embodiments, greater pressures may provide greater mass throughput. In some embodiments, increased energy transfer can lead to increased destruction.

The internal components of the device 100 may be in various configurations or arrangements including a single high voltage electrode disposed concentrically or coaxially within the ground or reference electrode, multiple concentric high voltage electrodes, parallel plate configurations, and multiple plate configurations.

FIG. 2 is a cross sectional view of a single electrode device 200 for generating hydrogen from a hydrocarbon. As seen in FIG. 2, the device 200 may comprise a shell 210, a grounded surface or electrode 220, a plurality of dielectric insulators 230a, 230b, a high voltage electrode 240, and a plurality of plasma zones 250a, 250b. Additionally, the device 200 comprises a fluid inlet, a fluid outlet, and a power supply/controller similar to those described in connection with FIG. 1. The components of FIG. 2 may be similar to those described with regard to FIG. 1. In this embodiment, the shell 200 is substantially a rectangular prism in shape.

The grounded surface or electrode 220 forms the shell 210. In some embodiments, the grounded surface or electrode 220 may be disposed on an inner surface 211 of the shell 210. In some embodiments, the grounded surface or electrode 220 may be disposed on a first side 213 and a second side of the shell 215.

Dielectric insulators 230a, 230b each have the form of a plate. Dielectric insulators 230a, 230b are disposed within the shell 210 such that they each contact the grounded surface or electrode 220. Additionally, dielectric insulators 220a, 220b are disposed in the shell 210 such that they are arranged parallel to each other.

The high voltage electrode 240 also has the form of a plate. The high voltage electrode 240 is disposed in the shell 210 such that the high voltage electrode 240 does not contact dielectric insulators 230a, 230b or the grounded surface or electrode 220. Additionally, high voltage electrode 240 is disposed in the shell 210 such that the high voltage electrode 240 is arranged parallel to the dielectric insulators 230a, 230b.

The high voltage electrode 240 is disposed in between the plurality of dielectric insulators 230a, 230b such that the plurality of plasma zones 250a, 250b separate the high voltage electrode 240 from the plurality of dielectric insulators 230a, 230b. Furthermore, the dielectric insulators 230a, 320b act as electrical barriers between the high voltage electrode 240 and the grounded surface or electrode 220, thereby preventing or reducing current flow between the grounded surface or electrode 220 and the high voltage electrode 240. In this configuration, the dielectric insulators 230a, 230b do not participate as a propagation point for the hydrocarbons in the fluid feed stream, thereby promoting a disassociation reaction over a propagation reaction within the device 200.

Power is supplied to the high voltage electrode 240 to generate a high voltage electric field within the plurality of plasma zones 250a, 250b of the shell 210. In some embodiments, power can be supplied to the electrode 240 in the form of an application voltage of between 100 VAC and 100,000 VAC, between 100 VAC and 10,000 VAC, between 500 VAC and 1,500 VAC, about 500 VAC, about 1,000 VAC, about 5,000 VAC, about 10,000 VAC, about 45,000 VAC, about 50,000 VAC, or any other suitable application voltage. In some embodiments, the electric field generated by the high voltage electrode 240 causes the disassociation of hydrocarbons passing through the plasma zones 250a, 250b of the shell 210.

Power supplied to the high voltage electrode 240 can be alternating current in various wave forms, ranging in voltage from 100 VAC to 10,000 VAC and frequencies from 60 Hz to 10,000 Hz. In some embodiments, power supplied to the high voltage electrode 240 can be direct current or pulsed direct current fields. In some embodiments, power supplied to the high voltage electrode 240 can be any combination of alternating current, direct current, and pulsed direct current fields.

The device 200 can operate at low, moderate, or high pressures depending on the application demand. In some embodiments, the pressure can be between 1 psig and 10 psig. In some embodiments, the pressure can be 2 psig. In some embodiments, the pressure may be related to the amount of hydrocarbon destruction. For example, in some embodiments, greater pressures may lead to greater amounts of hydrocarbon destruction. In some embodiments, increasing pressure may force the molecules of the feed gas into closer proximity and increase gas conductivity. This may improve energy transfer through the gas phase. In some embodiments, greater pressures may provide greater mass throughput. In some embodiments, increased energy transfer can lead to increased destruction. In some embodiments, existing methane/steam cracking may be modified to include features of the embodiments described herein to perform hydrocarbon destruction.

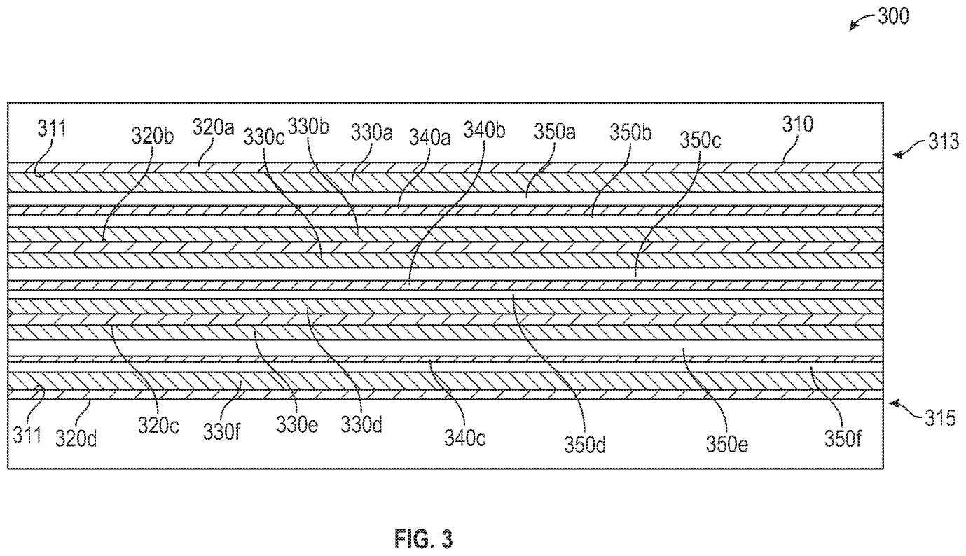

FIG. 3 is a cross sectional view of a multiple electrode device 300 for generating hydrogen from a hydrocarbon. The device 300 may comprise a shell 310, a plurality of grounded surfaces or electrodes 320a, 320b, 320c, 320d, a plurality of dielectric insulators 330a, 330b, 330c, 330d, 330e, 330f, a plurality of high voltage electrodes 340a, 340b, 340c, and a plurality of plasma zones 350a, 350b, 350c, 350d, 350e, 350f. Additionally, the device 300 comprises a fluid inlet, a fluid outlet, and a power supply/controller similar to those described in connection with FIG. 1. The components of FIG. 3 may be similar to those described with regard to FIG. 1A, FIG. 1B, and FIG. 2. In this embodiment, the shell 300 is substantially rectangular in shape.

As seen in FIG. 3, grounded surfaces or electrodes 320a, 320d form the shell 310. In some embodiments, the grounded surfaces or electrodes 320a, 320d may be disposed on an inner surface 311 of the shell 310, grounded surface or electrode 320a being disposed on an inner surface 311 of the shell 310 on a first side 313 of the shell 310 and grounded surface or electrode 320d being disposed on an inner surface 311 of the shell 310 on a second side 315 of the shell 310.

Grounded surfaces or electrodes 320b, 320c each have the form of a plate. The grounded surfaces or electrodes 320b, 320c are disposed in the shell 311 such that grounded surfaces or electrodes 320a, 320b, 320c, 320d do not contact each other. In some embodiments, grounded surfaces or electrodes 320a, 320b, 320c, 320d are arranged parallel to each other.

Dielectric insulators 330a, 330b, 330c, 330d, 330e, 330f each have the form of a plate. Dielectric insulators 330a, 330b, 330c, 330d, 330e, 330f are disposed within the shell 310 such that they each contact at least one of the grounded surfaces or electrodes 320a, 320b, 320c, 320d. Additionally, dielectric insulators 330a, 330b, 330c, 330d, 330e, 330f are disposed in the shell 310 such that they are arranged parallel to the grounded surfaces or electrodes 320b, 320c. As seen in FIG. 3, dielectric insulator 330a is disposed within the shell 310 such that it contacts grounded surface or electrode 320a. Dielectric insulators 330b, 330c are disposed within the shell 310 such that they contact grounded surface or electrode 320b, wherein dielectric insulator 330b contacts one side of the grounded surface or electrode 320b and dielectric insulator 330c contacts the opposite side of the grounded surface or electrode 320b. Dielectric insulators 330d, 330e are disposed within the shell 310 such that they contact grounded surface or electrode 320c, wherein dielectric insulator 330d contacts one side of the grounded surface or electrode 320c and dielectric insulator 330e contacts the opposite side of the grounded surface or electrode 320c. Dielectric insulator 330f is disposed within the shell 310 such that it contacts grounded surface or electrode 320d.

The high voltage electrodes 340a, 340b, 340c also have the form of a plate. The high voltage electrodes 340a, 340b, 340c are disposed in the shell 311 such that the high voltage electrodes 340a, 340b, 340c do not contact each other, the dielectric insulators 330a, 330b, 330c, 330d, 330e, 330f, or the grounded surfaces or electrodes 320a, 320b, 320c, 320d. Additionally, high voltage electrodes 340a, 340b, 340c are disposed in the shell 310 such that they are arranged parallel to the dielectric insulators 330a, 330b, 330c, 330d, 330e, 330f and the grounded surfaces or electrodes 320b, 320c.

The high voltage electrode 340a is disposed between the dielectric insulators 330a, 330b such that the plasma zones 350a, 350b separate the high voltage electrode 340a from the dielectric insulators 330a, 330b. High voltage electrode 340b is disposed in between the dielectric insulators 330c, 330d such that the plasma zones 350c, 350d separate the high voltage electrode 340b from the dielectric insulators 330c, 330d. High voltage electrode 340c is disposed in between the dielectric insulators 330e, 330f such that the plasma zones 350e, 350f separate the high voltage electrode 340c from the dielectric insulators 330e, 330f. Furthermore, the dielectric insulators 330a, 330b, 330c, 330d, 330e, 330f act as electrical barriers between the high voltage electrodes 340a, 340b, 340c and the grounded surfaces or electrodes 320a, 320b, 320c, 320d, thereby preventing or reducing current flow between the grounded surfaces or electrodes 320a, 320b, 320c, 320d and the high voltage electrodes 340a, 340b, 340c. In this configuration, the dielectric insulators 330a, 330b, 330c, 330d, 330e, 330f do not participate as a propagation point for the hydrocarbons in the fluid feed stream, thereby promoting a disassociation reaction over a propagation reaction within the device 300.

Power is supplied to the high voltage electrodes 340a, 340b, 340c to generate a high voltage electric field within the plurality of plasma zones 350a, 350b, 350c, 350d, 350e, 350f of the shell 310. In some embodiments, power can be supplied to the electrodes 340a, 340b, 340c in the form of an application voltage of between 100 VAC and 100,000 VAC, between 100 VAC and 10,000 VAC, between 500 VAC and 1,500 VAC, about 500 VAC, about 1,000 VAC, about 5,000 VAC, about 10,000 VAC, about 45,000 VAC, about 50,000 VAC, or any other suitable application voltage. In some embodiments, the electric field generated by the high voltage electrodes 340a, 340b, 340c causes the disassociation of hydrocarbons passing through the plasma zones 350 of the shell 310.

In some embodiments, a single power supply/controller is coupled to the high voltage electrodes 340a, 340b, 340c, for example, via a high voltage cable. In some embodiments, each high voltage electrode 340a, 340b, 340c is electrically coupled to a separate power supply/controller. In some embodiments, a high voltage cable can extend between the power supply/controller and the electrodes 340a, 340b, 340c through a fluid inlet. In some embodiments, the device 300 can include a high voltage entrance device. The high voltage entrance device may be a high voltage insulator entrance bushing.

Power supplied to the high voltage electrodes 340 can be alternating current in various wave forms, ranging in voltage from 100 VAC to 10,000 VAC and frequencies from 60 Hz to 10,000 Hz. In some embodiments, power supplied to the high voltage electrode 340 can be direct current or pulsed direct current fields. In some embodiments, power supplied to the high voltage electrode 340 can be any combination of alternating current, direct current, and pulsed direct current fields.

The device 300 can operate at low, moderate, or high pressures depending on the application demand. In some embodiments, the pressure can be between 1 psig and 10 psig. In some embodiments, the pressure can be 2 psig. In some embodiments, the pressure may be related to the amount of hydrocarbon destruction. For example, in some embodiments, greater pressures may lead to greater amounts of hydrocarbon destruction. In some embodiments, increasing pressure may force the molecules of the feed gas into closer proximity and increase gas conductivity. This may improve energy transfer through the gas phase. In some embodiments, greater pressures may provide greater mass throughput. In some embodiments, increased energy transfer can lead to increased destruction. In some embodiments, existing methane/steam cracking may be modified to include features of the embodiments described herein to perform hydrocarbon destruction.

in some embodiments, the device 300 can have a common inlet plenum and outlet plenum at the ends of the device 200 (not shown) which puts each of plasma zones 350a-f in fluid connection with each other. In some embodiments, each of the plasma zones can be isolated from the others via an inlet manifold or similar feature. In some embodiments, plasma zones proximate the same high voltage electrode can be a single channel, fluidly separate from an adjacent portion. For example, plasma zones 350a and 350b are both in contact with high voltage electrode 340a. Plasma zones 350a and 350b can be in fluid connection with each other, or together surround the high voltage electrode 340a. Arrangements as described herein with regard to FIG. 3 may be beneficial for increasing the usable volume in within the device 300 by having an increased volume of plasma zones 350a, 350b, 350c, 350d, 350e, 350f in the device 300. This configuration may be beneficial for increasing the number of disassociation reactions occurring within the plasma zones 350a, 350b, 350c, 350d, 350e, 350f of the device 300, thereby increasing the amount of hydrogen generated.

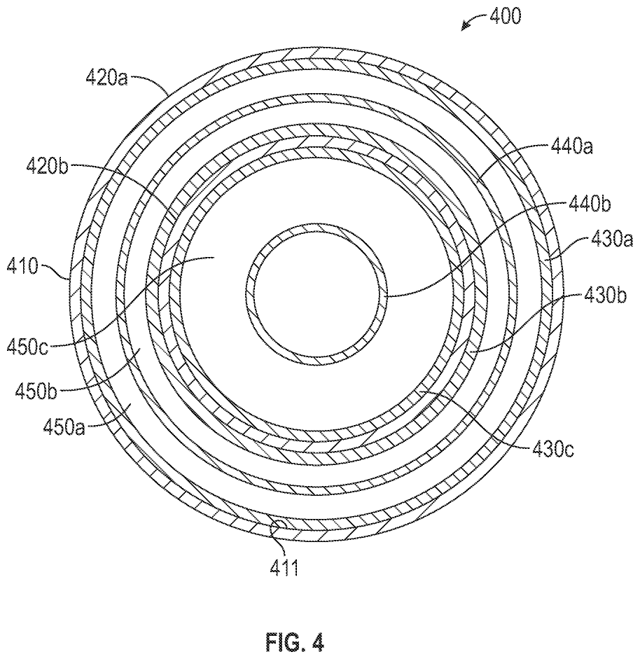

FIG. 4 shows a cross-sectional view of a device 400 where the internal components are arranged in a multiple concentric arrangement. As seen in FIG. 4, the device 400 comprises a shell 410, a plurality of grounded surfaces or electrodes 420a, 420b, a plurality of dielectric insulators 430a, 430b, 430c, a plurality of high voltage electrodes 440a, 440b, and a plurality of plasmas zones 450a, 450b, 450c arranged in multiple concentric arrangement. Additionally, the device 400 comprises a fluid inlet, a fluid outlet, and a power supply/controller similar to those described in connection with FIG. 1. The components of FIG. 4 may be similar to those described with regard to FIG. 1A, FIG. 1B, FIG. 2 and FIG. 3. In this embodiment, the shell 400 is substantially cylindrical in shape.

As seen in FIG. 4, grounded surface or electrode 420a forms the shell 410. In some embodiments, the grounded surfaces or electrode 420a may be disposed on an inner surface 411 of the shell 410. Grounded surface of electrode 420b is annular in shape and is disposed concentrically or coaxially within the shell 410 such that the grounded surface or electrode 420b does not contact the grounded surface or electrode 420a. The components of the device 400 can be similar to others described herein.

Dielectric insulators 430a, 430b, 430c are each annular in shape. Dielectric insulators 430a, 430b, 430c are disposed concentrically or coaxially within the shell 410 such that they each contact at least one of the grounded surfaces or electrodes 420a, 420b. As seen in FIG. 4, dielectric insulator 430a is disposed within the shell 410 such that it contacts grounded surface or electrode 420a. Dielectric insulators 430b, 430c are disposed within the shell 410 such that they contact grounded surface or electrode 420b, wherein dielectric insulator 430b contacts one side of the grounded surface or electrode 420b and dielectric insulator 430c contacts an opposite side of the grounded surface or electrode 420b.

High voltage electrode 440a is annular in shape. In some embodiments, high voltage electrode 440b may be annular in shape. In some embodiments, high voltage electrode 440b can be a rod or a cylinder, such as a hollow cylinder. The high voltage electrodes 440a, 440b are disposed concentrically or coaxially in the shell 411 such that high voltage electrodes 440a, 440b do not contact each other, the dielectric insulators 430a, 430b, 430c or the grounded surfaces or electrodes 420a, 420b.

As seen in FIG. 4, high voltage electrode 440a is disposed in between the dielectric insulators 430a, 430b such that the plasma zones 450a, 450b separate the high voltage electrode 440a from the dielectric insulators 430a, 430b. High voltage electrode 440b is disposed near a center of the shell 410 such that the plasma zone 450c separates the high voltage electrode 440b from the dielectric insulator 430c. Furthermore, the dielectric insulators 430a, 430b, 430c act as electrical barriers between the high voltage electrodes 440a, 440b and the grounded surfaces or electrodes 420a, 420b, thereby preventing or reducing current flow between the grounded surfaces or electrodes 420a, 420b and the high voltage electrodes 440a, 440b. In this configuration, the dielectric insulators 430a, 430b, 430c do not participate as a propagation point for the hydrocarbons in the fluid feed stream, thereby promoting a disassociation reaction over a propagation reaction within the device 400. In some embodiments, additional grounded surfaces or electrodes, dielectric insulators, and high voltage electrodes may be added.

In certain embodiments, power can be supplied to the plurality of high voltage electrodes 440a, 440b to generate a high voltage electric field within the plurality of plasma zones 450a, 450b, 450c of the device 400. In some embodiments, power can be supplied to the plurality of high voltage electrodes 440a, 440b in the form of an application voltage of between 100 VAC and 100,000 VAC, between 100 VAC and 10,000 VAC, between 500 VAC and 1,500 VAC, about 500 VAC, about 1,000 VAC, about 5,000 VAC, about 10,000 VAC, about 45,000 VAC, about 50,000 VAC, or any other suitable application voltage. In some embodiments, the electric field generated by the plurality of high voltage electrodes 440a, 440b causes the disassociation of hydrocarbons passing through the plurality of plasma zones 450a, 450b, 450c of the device 400.

In some embodiments, a single power supply/controller is coupled to the high voltage electrodes 440a, 440b for example, via a high voltage cable. In some embodiments, each high voltage electrode 440a, 440b is electrically coupled to a separate power supply/controller. In some embodiments, a high voltage cable can extend between the power supply/controller and the electrodes 440a, 440b through a fluid inlet. In some embodiments, the device 400 can include a high voltage entrance device. The high voltage entrance device may be a high voltage insulator entrance bushing.

Power supplied to the electrodes 440a, 440b can be alternating current in various wave forms, ranging in voltage from 100 VAC to 10,000 VAC and frequencies from 60 Hz to 10,000 Hz. In some embodiments, power supplied to the electrodes 440a, 440b can be direct current or pulsed direct current fields. In some embodiments, power supplied to the electrodes 504 can be any combination of alternating current, direct current, and pulsed direct current fields.

The device 400 can operate at low, moderate, or high pressures depending on the application demand. In some embodiments, the pressure can be between 1 psig and 10 psig. In some embodiments, the pressure can be 2 psig. In some embodiments, the pressure may be related to the amount of hydrocarbon destruction. For example, in some embodiments, greater pressures may lead to greater amounts of hydrocarbon destruction. In some embodiments, increasing pressure may force the molecules of the feed gas into closer proximity and increase gas conductivity. This may improve energy transfer through the gas phase. In some embodiments, greater pressures may provide greater mass throughput. In some embodiments, increased energy transfer can lead to increased destruction. In some embodiments, existing methane/steam cracking may be modified to include features of the embodiments described herein to perform hydrocarbon destruction.

This configuration may be beneficial for increasing the usable volume in within the device 400 by having an increased volume of plasma zones 450a, 450b in the device 400. This configuration may be beneficial for increasing the number of disassociation reactions occurring within the plasma zones 450a, 450b of the device 400, thereby increasing the amount of hydrogen generated.

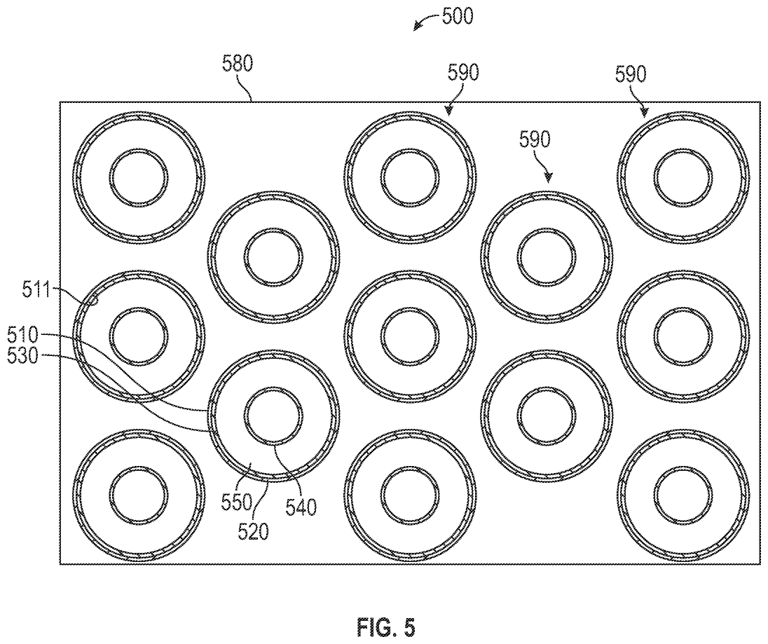

FIG. 5 shows a cross-sectional view of an embodiment of a device 500 where the components are in a multiple independent concentric arrangement. The device 500 comprises an external containment 580 and a plurality of tubes 590. In this embodiment, the external containment 580 is substantially rectangular in shape. The exterior containment 580 encloses the plurality of tubes 590. Each tube 590 is substantially cylindrical in shape. Each tube 590 comprises a shell 510, a grounded surface or electrode 520, a dielectric insulator 530, a high voltage electrode 540 and a plasma zone 550. Additionally, the device 500 comprises a fluid inlet, a fluid outlet, and a power supply/controller similar to those described in connection with FIG. 1. The components of FIG. 5 may be similar to those described with regard to FIG. 1A, FIG. 1B, FIG. 2, FIG. 3 and FIG. 4.

In some embodiments, the fluid inlet of device 500 may be connected to the plurality of tubes 590. In some embodiments, each tube 590 may be connected to a separate fluid inlet. In some embodiments, the fluid outlet of device 500 may be connected to the plurality of tubes 590. In some embodiments, each tube 590 may be connected to a separate fluid outlet. In some embodiments, each of the tubes may be connected to a common inlet plenum and a common outlet plenum. In some embodiments, the plurality of tubes 590 can be triangular, rectangular, square, and the like.

The grounded surface or electrode 520 of each tube 590 forms the shell 510 of each tube 590. In some embodiments, the grounded surface or electrode 520 of each tube 590 may be disposed on an inner surface 511 of the shell 510. In some embodiments, the grounded surface of electrode 520 is annular in shape and is disposed concentrically or coaxially within the shell 510.

As seen in FIG. 5, the dielectric insulator 530 is disposed concentrically or coaxially within the shell 510 such that the dielectric insulator 530 contacts the grounded surface or electrode 520. In some embodiments, the dielectric insulator 530 may cover the entire grounded surface or electrode 520. In some embodiments, the dielectric insulator 530 may only cover a portion of the grounded surface or electrode 520. In some embodiments, the dielectric insulator 530 may act as an electric insulator for an electric field generated by the high voltage electrode 540.

As seen in FIG. 5, the high voltage electrode 540 is annular in shape and is disposed concentrically or coaxially within the shell 510 such that it does not contact the grounded surface or electrode 520 or the dielectric insulator 530. The high voltage electrode 540 is disposed within the shell 510 such that it is separated from the dielectric insulator 530 by a plasma zone 550. In some embodiments, the high voltage electrode 540 can be a rod or a cylinder, such as a hollow cylinder.

The dielectric insulator 530 acts as electrical barriers between the high voltage electrode 540 and the grounded surface or electrode 520 thereby preventing or reducing current flow between the grounded surface or electrode 520 and the high voltage electrode 540. In this configuration, the dielectric insulator 530 does not participate as a propagation point for the hydrocarbons in the fluid feed stream, thereby promoting a disassociation reaction over a propagation reaction within each of the tubes 590 of the device 500.

Power is supplied to the high voltage electrode 540 to generate a high voltage electric field within the plasma zone 550 of each tube 590. In some embodiments, power can be supplied to the electrode 540 in the form of an application voltage of between 100 VAC and 100,000 VAC, between 100 VAC and 10,000 VAC, between 500 VAC and 1,500 VAC, about 500 VAC, about 1,000 VAC, about 5,000 VAC, about 10,000 VAC, about 45,000 VAC, about 50,000 VAC, or any other suitable application voltage. In some embodiments, the electric field generated by the high voltage electrode 540 causes the disassociation of hydrocarbons passing through the plasma zone 550 of each tube 590.

In some embodiments, a single power supply/controller is coupled to the high voltage electrode 540 of each tube 590 for example, via a high voltage cable. In some embodiments, the high voltage electrode 540 of each tube 590 is electrically coupled to a separate power supply/controller. In some embodiments, a high voltage cable can extend between the power supply/controller and the high voltage electrode 540 of each tube 590. through a fluid inlet. In some embodiments, the device 500 can include a high voltage entrance device. The high voltage entrance device may be a high voltage insulator entrance bushing.

Power supplied to the electrode 540 can be alternating current in various wave forms, ranging in voltage from 100 VAC to 10,000 VAC and frequencies from 60 Hz to 10,000 Hz. In some embodiments, power supplied to the electrode 540 can be direct current or pulsed direct current fields. In some embodiments, power supplied to the electrode 540 can be any combination of alternating current, direct current, and pulsed direct current fields.

The device 500 can operate at low, moderate, or high pressures depending on the application demand. In some embodiments, the pressure can be between 1 psig and 10 psig. In some embodiments, the pressure can be 2 psig. In some embodiments, the pressure may be related to the amount of hydrocarbon destruction. For example, in some embodiments, greater pressures may lead to greater amounts of hydrocarbon destruction. In some embodiments, increasing pressure may force the molecules of the feed gas into closer proximity and increase gas conductivity. This may improve energy transfer through the gas phase. In some embodiments, greater pressures may provide greater mass throughput. In some embodiments, increased energy transfer can lead to increased destruction. In some embodiments, existing methane/steam cracking may be modified to include features of the embodiments described herein to perform hydrocarbon destruction.

This configuration may be beneficial for increasing the usable volume in within the device 500 by having an increased volume of plasma zone 550 in the device 500. This configuration may be beneficial for increasing the number of disassociation reactions occurring within the plasma zones 550 of the device 500, thereby increasing the amount of hydrogen generated.

One of skill in the art would understand, aided by the current disclosure, that different vessel sizes and shapes can be used, or different numbers of plates could be used without departing from the scope of this invention.

### Operational Observations

Operations were conducted using a device having the configuration of the device 100 as shown in FIG. 1. High voltage was applied to a high voltage electrode, such as high voltage electrode 104, through a high voltage entrance device, such as high voltage entrance device 107, from a power supply/controller, such as power supply/controller 108. Compressed Natural Gas (CNG) was supplied into the device via a fluid inlet, such as fluid inlet 105 and was subjected to a high voltage field. Voltages applied ranged from 30 KV to 50 KV with frequencies ranging from 400 Hz to 1,000 Hz. Gas flow exited the device via a fluid outlet, such as fluid outlet 106.

The device also included a dielectric insulator, such as dielectric insulator 103 and a grounded surface or electrode, such as grounded surface or electrode 102. Hydrocarbon compositions of the feed and exit gases were measured by gas chromatography.

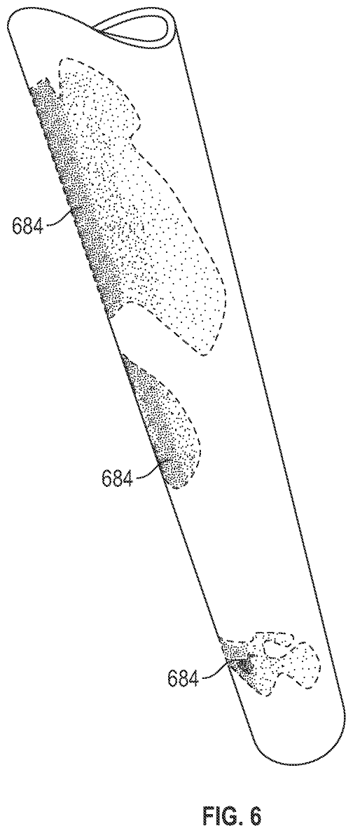

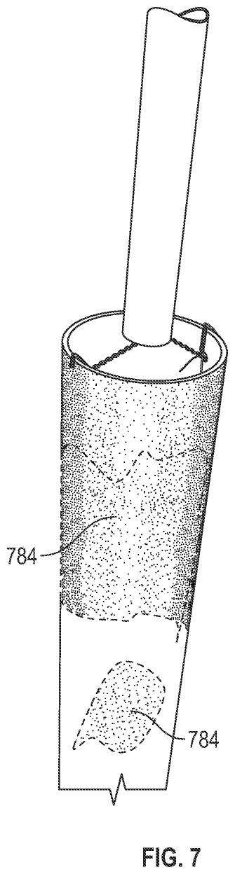

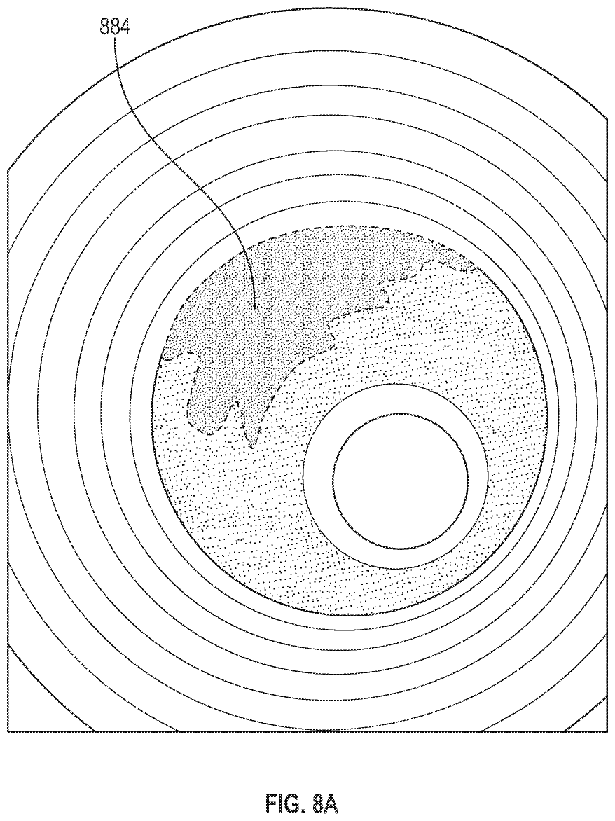

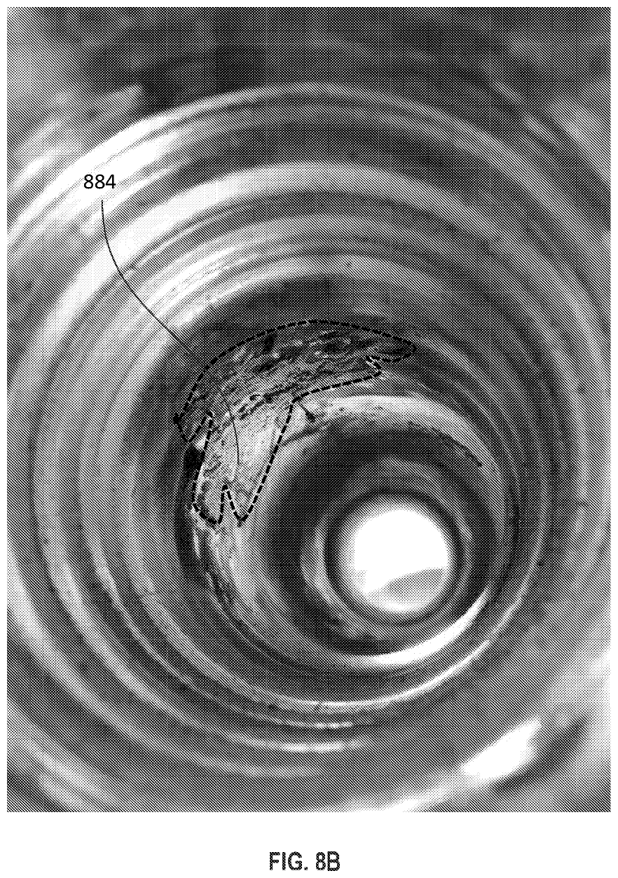

Upon completion of the operational runs, the device was disassembled for internal inspection. FIGS. 6 and 7 depict the high voltage electrode following disassembly of the device after completion of the test sequence. As shown in FIGS. 6 and 7, carbon deposition 684, 784 was visible on the surface of the high voltage electrode. FIG. 8A shows an illustration and FIG. 8B is an image of the dielectric insulator following disassembly of the device after completion of the test sequence. As shown in FIGS. 8A-8B, the carbon deposition 884 was visible on the surface of the dielectric insulator.

### Results

As a control, feed gas was run through the device and no voltage was applied. The composition of the exit gas collected after running the feed gas through device without operating the device was equivalent or substantially equivalent to the composition of the feed gas, indicating that only negligible reactions, if any occurred.

A gas chromatogram measuring the composition of exit gas collected after running feed gas through device without operating the device is shown in Table 1. The gas chromatograms used a flame ionization detector (FID) for hydrocarbon analysis using hydrogen as flame fuel source.

TABLE 1

| RetTime | | Area | | Amount | | |
|---|---|---|---|---|---|---|
| [min] | Type | [pA*s] | Amt/Area | [%] | Grp | Name |
| 1.485 | BV S | 1.96565e5 | 4.72780e−4 | 92.93218 | | Methane |
| 1.925 | VB S | 5386.13135 | 2.50538e−4 | 1.34943 | | Ethane |
| 2.743 | | — | — | — | | Ethene (Ethylene) |
| 3.654 | BB | 190.85135 | 1.68827e−4 | 3.22208e−2 | | Propane |
| 6.156 | | — | — | — | | Propene (Propylene) |
| 6.711 | | — | — | — | | 2-methylpropane (isobutane) |
| 7.026 | BB | 22.99347 | 1.22204e−4 | 2.80990e−3 | | Butane |
| 7.181 | | — | — | — | | Propadiene |
| 7.210 | | — | — | — | | Ethyne (acetylene) |
| 9.243 | | — | — | — | | trans-2-Butene |
| 9.493 | | — | — | — | | 1-Butene |
| 9.819 | | — | — | — | | cis-2-Butene |
| 10.000 | | — | — | — | | 2-Methylpropene (isobutylene) |
| 10.377 | | — | — | — | | 2-Methylbutane (isopentane) |
| 10.592 | | — | — | — | | Pentane |
| 11.170 | | — | — | — | | 1,3-Butadiene |
| 12.242 | | — | — | — | | trans-2-Pentene |
| 12.498 | | — | — | — | | 2-Methyl-2-butene |
| 12.714 | | — | — | — | | 1-Pentene |
| 12.839 | | — | — | — | | cis-2-Pentene |
| 12.988 | | — | — | — | | Hexane |
| 14.052 | | — | — | — | | 4-Vinyl-1-cyclohexene |
| Totals: | | | | 94.31664 | | |

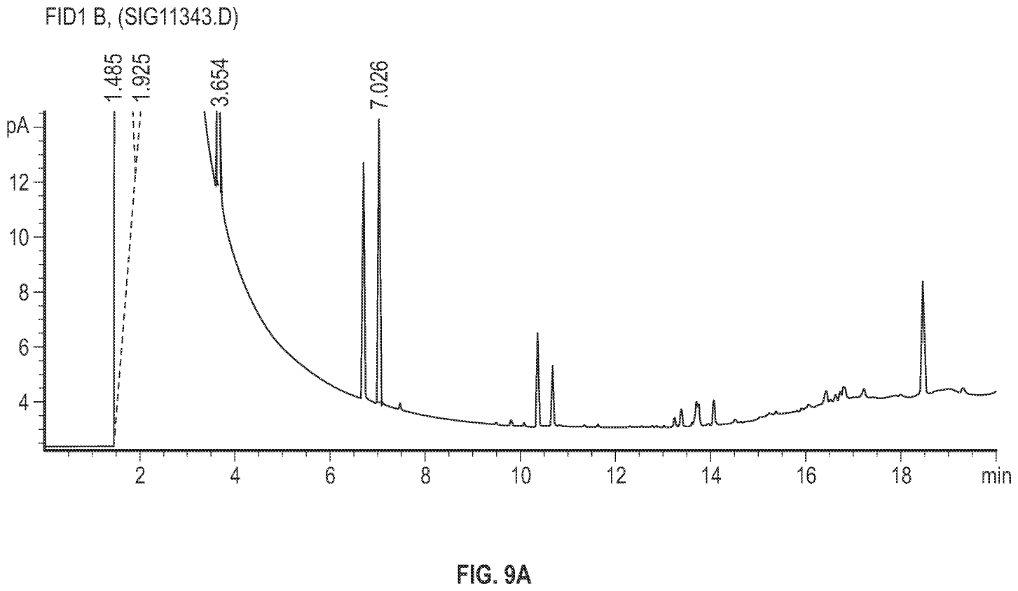

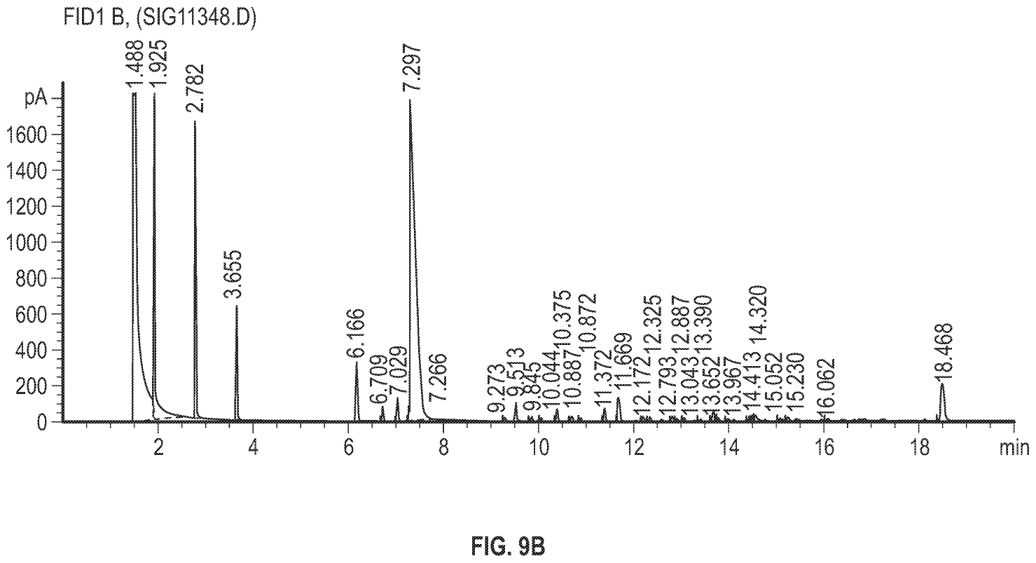

The results in Table 1 are depicted graphically in FIG. 9A. It can be seen that little or no hydrocarbon disassociation or destruction occurred when the device is not operating. The results in Table 1 are, therefore, indicative of the composition of the feed gas, and will be used for comparison hereafter.

In a first run, compressed natural gas (CNG) having the composition of Table 1 was supplied to the reactor at a feed rate of 1.02 SLPM (relative N₂) and had an average residence time of 57 seconds within the device. An applied voltage supplied to the electrode was 50,000 VAC with a frequency of 1,000 Hz.

Table 2 shows the composition of exit gas collected after running feed gas (of the composition in Table 1) through device while operating the device to subject the feed gas to a high voltage electric field. The results of Table 2 are depicted graphically in FIG. 9B.

TABLE 2

| RetTime | | Area | | Amount | | |
|---|---|---|---|---|---|---|
| [min] | Type | [pA*s] | Amt/Area | [%] | Grp | Name |
| 1.488 | BV S | 1.23983e5 | 4.72780e−4 | 58.61668 | | Methane |
| 1.925 | VB S | 4730.87500 | 2.50538e−4 | 1.18526 | | Ethane |
| 2.782 | BB S | 2325.62183 | 2.52976e−4 | 5.88328e−1 | | Ethene (Ethylene) |
| 3.655 | BB | 1030.13391 | 1.68827e−4 | 1.73914e−1 | | Propane |
| 6.166 | BB | 688.18188 | 1.76025e−4 | 1.21137e−1 | | Propene (Propylene) |
| 6.709 | BB | 191.96062 | 1.25657e−4 | 2.41212e−2 | | 2-methylpropane (isobutane) |
| 7.029 | BB | 297.16116 | 1.22204e−4 | 3.63143e−2 | | Butane |
| 7.266 | BV | 94.99000 | 2.91756e−4 | 2.77139e−2 | | Propadiene |
| 7.297 | VB S | 1.41252e4 | 1.74931e−4 | 2.47094 | | Ethyne (acetylene) |
| 9.273 | BB | 48.02766 | 1.34314e−4 | 6.45077e−3 | | trans-2-Butene |
| 9.513 | BB | 231.02199 | 1.28497e−4 | 2.96857e−2 | | 1-Butene |
| 9.845 | BB | 80.45164 | 1.28621e−4 | 1.03478e−2 | | cis-2-Butene |
| 10.044 | BB | 40.03272 | 1.31332e−4 | 5.25757e−3 | | 2-Methylpropene (isobutylene) |
| 10.375 | BB | 172.02048 | 1.02070e−4 | 1.75581e−2 | | 2-Methylbutane (isopentane) |
| 10.687 | BB | 57.67453 | 1.06686e−4 | 6.15305e−3 | | Pentane |
| 11.669 | BB | 362.37003 | 1.31919e−4 | 4.78036e−2 | | 1,3-Butadiene |
| 12.172 | BB | 60.27646 | 1.17064e−4 | 7.05623e−3 | | trans-2-Pentene |
| 12.325 | BB | 56.16860 | 1.30452e−4 | 7.32731e−3 | | 2-Methyl-2-butene |
| 12.793 | BV | 65.94004 | 1.07787e−3 | 7.10751e−2 | | cis-2-Pentene |
| 12.887 | VB | 28.37309 | 1.11299e−4 | 3.15789e−3 | | 1-Pentene |
| 13.390 | BB | 28.34670 | 5.84505e−5 | 1.65688e−3 | | Hexane |
| 13.967 | BV | 40.39522 | 1.30893e−4 | 5.28745e−3 | | 4-Vinyl-1-cyclohexene |
| Totals: | | | | 63.46323 | | |

Data analysis comparing the composition of the exit gas collected after running the feed gas through device without operating the device and the composition of the exit gas collected after operating the device on the feed gas indicated a significant shift in the total mass of hydrocarbons present after the feed gas had been passed through the high voltage field in the test runs of interest.

It can be seen that the percent of methane in the feed gas has been greatly reduced, and that very small amounts of longer chain hydrocarbons have been produced, indicating that the primary reaction mechanism is disassociation and not propagation.

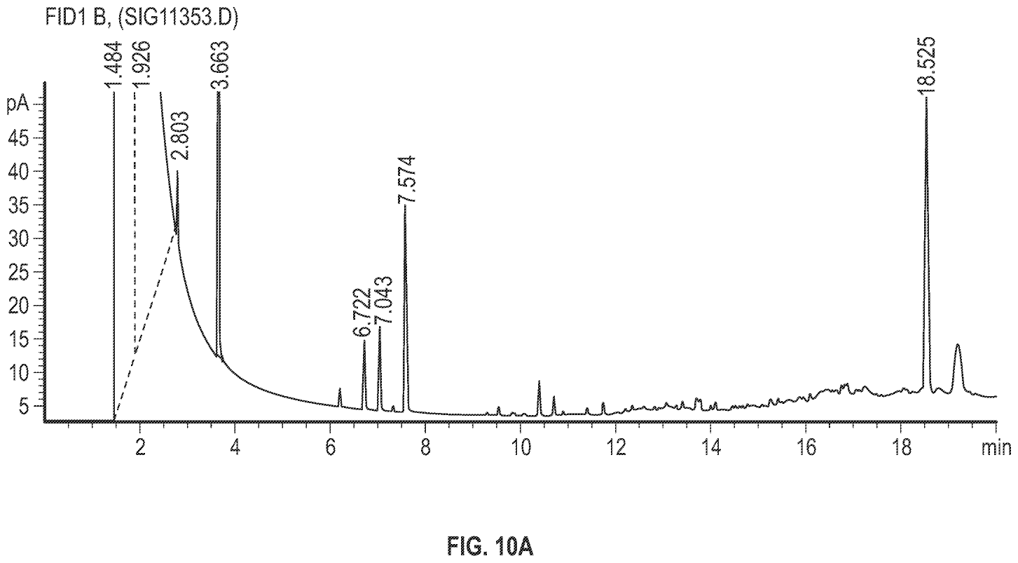

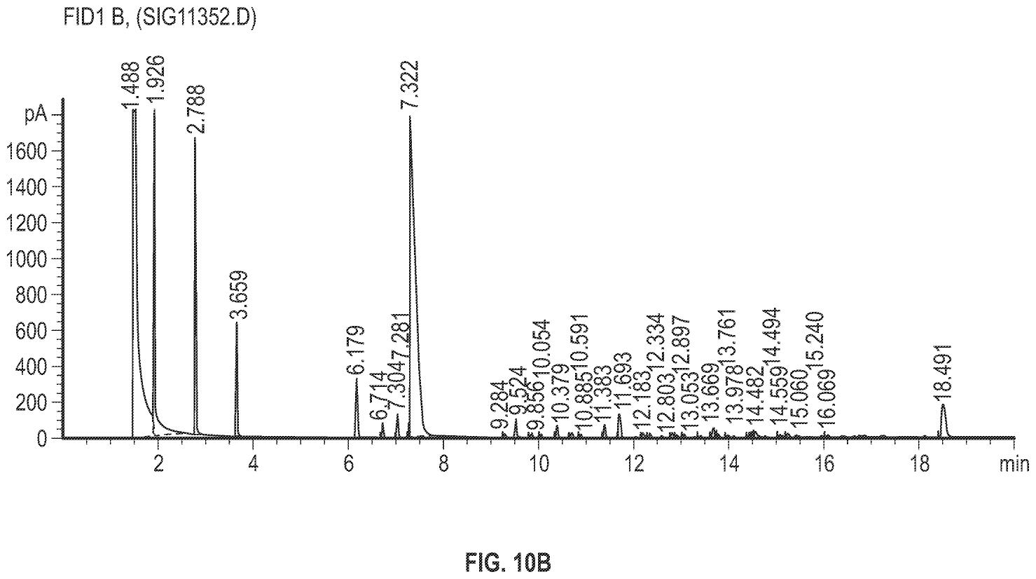

Table 3 shows the composition of a feed gas for a second run. A gas chromatogram showing the values in Table 3 is shown in FIG. 10A. The gas chromatograms used a flame ionization detector (FID) for hydrocarbon analysis using hydrogen as flame fuel source.

TABLE 3

| RetTime | | Area | | Amount | | |
|---|---|---|---|---|---|---|
| [min] | Type | [pA*s] | Amt/Area | [%] | Grp | Name |
| 1.484 | BV S | 2.01465e5 | 4.72780e−4 | 95.24848 | | Methane |
| 1.926 | VB S | 5490.37158 | 2.50538e−4 | 1.37555 | | Ethane |
| 2.803 | BB | 11.98700 | 2.52976e−4 | 3.03243e−3 | | Ethene (Ethylene) |
| 3.663 | BB | 208.04144 | 1.68827e−4 | 3.51230e−2 | | Propane |
| 6.156 | | — | — | — | | Propene (Propylene) |
| 6.722 | BB | 22.37937 | 1.25657e−4 | 2.81212e−3 | | 2-methylpropane (isobutane) |
| 7.043 | BB | 27.95672 | 1.22204e−4 | 3.41643e−3 | | Butane |
| 7.292 | | — | — | — | | Propadiene |
| 7.574 | BB | 68.59993 | 1.74931e−4 | 1.20002e−2 | | Ethyne (acetylene) |
| 9.243 | | — | — | — | | trans-2-Butene |
| 9.493 | | — | — | — | | 1-Butene |
| 9.819 | | — | — | — | | cis-2-Butene |
| 18.000 | | — | — | — | | 2-Methylpropene (isobutylene) |
| 10.691 | | — | — | — | | 2-Methylbutane (isopentane) |
| 11.383 | | — | — | — | | Pentane |
| 11.682 | | — | — | — | | 1,3-Butadiene |
| 12.242 | | — | — | — | | trans-2-Pentene |
| 12.498 | | — | — | — | | 2-Methyl-2-butene |
| 12.714 | | — | — | — | | 1-Pentene |
| 12.839 | | — | — | — | | cis-2-Pentene |
| 13.670 | | — | — | — | | Hexane |
| 14.052 | | — | — | — | | 4-Vinyl-1-cyclohexene |
| Totals: | | | | 96.68041 | | |

In a second run, CNG having the composition of Table 3 was supplied at a feed rate of 0.87 SLPM (relative N₂) and had an average residence time of 67 seconds within the device. An applied voltage supplied to the electrode was 45,000 VAC with a frequency of 600 Hz. Table 4 depicts the composition of the exit stream of the second run measured by gas chromatography. Similar to the previous tables, it can be seen that the percent composition of methane in the feed has been greatly reduced, and only negligible amounts of longer chain hydrocarbons have been produced.

TABLE 4

| RetTime | | Area | | Amount | | |
|---|---|---|---|---|---|---|
| [min] | Type | [pA*s] | Amt/Area | [%] | Grp | Name |
| 1.488 | BV S | 1.25103e5 | 4.72780e−4 | 59.14610 | | Methane |
| 1.926 | VB S | 4800.50586 | 2.50538e−4 | 1.20271 | | Ethane |
| 2.788 | BB | 2106.75732 | 2.52976e−4 | 5.32960e−1 | | Ethene (Ethylene) |
| 3.659 | BB | 954.82867 | 1.68827e−4 | 1.61201e−1 | | Propane |
| 6.179 | BB | 639.86786 | 1.76025e−4 | 1.12633e−1 | | Propene (Propylene) |
| 6.714 | BB | 176.21638 | 1.25657e−4 | 2.21428e−2 | | 2-methylpropane (isobutane) |
| 7.034 | BB | 251.93623 | 1.22204e−4 | 3.07877e−2 | | Butane |
| 7.281 | BV | 118.86867 | 2.91756e−4 | 3.46806e−2 | | Propadiene |
| 7.322 | VB S | 1.38608e4 | 1.74931e−4 | 2.42468 | | Ethyne (acetylene) |
| 9.284 | BB | 40.73455 | 1.34314e−4 | 5.47120e−3 | | trans-2-Butene |
| 9.524 | BB | 213.74707 | 1.28497e−4 | 2.74659e−2 | | 1-Butene |
| 9.856 | BB | 71.40253 | 1.28621e−4 | 9.18386e−3 | | cis-2-Butene |
| 10.054 | BB | 33.86111 | 1.31332e−4 | 4.44704e−3 | | 2-Methylpropene (isobutylene) |
| 10.691 | BB | 44.89194 | 1.02070e−4 | 4.58211e−3 | | 2-Methylbutane (isopentane) |
| 11.383 | BB | 140.57739 | 1.06686e−4 | 1.49976e−2 | | Pentane |
| 11.693 | BB | 372.10153 | 1.31919e−4 | 4.90874e−2 | | 1,3-Butadiene |
| 12.183 | BB | 57.36065 | 1.17064e−4 | 6.71489e−3 | | trans-2-Pentene |
| 12.334 | BB | 49.95210 | 1.30452e−4 | 6.51635e−3 | | 2-Methyl-2-butene |
| 12.803 | BV | 53.22443 | 1.07787e−3 | 5.73693e−2 | | cis-2-Pentene |
| 12.897 | VB | 24.09643 | 1.11299e−4 | 2.68190e−3 | | 1-Pentene |
| 13.669 | BV | 198.49669 | 5.84505e−5 | 1.16022e−2 | | Hexane |
| 13.978 | BV | 43.46367 | 1.30893e−4 | 5.68909e−3 | | 4-Vinyl-1-cyclohexene |
| Totals: | | | | 63.87370 | | |

Comparing the first and second runs, there is a correlation between the applied voltage and the residence time. For example, in some embodiments, increasing the residence time can allow for reducing the applied voltage, within a range capable of generating a plasma, and vice versa.

The data from the first and second runs were averaged. Average hydrocarbon composition from the gas chromatograms of FIGS. 9A and 10A is shown in TABLE 5.

TABLE 5
Average Hydrocarbon Composition (without operating the device)

| Compound | Percentage Composition (%) |
|---|---|
| Methane | 94.0903 |
| Ethane | 1.3625 |
| Ethylene | 0.0015 |
| Propane | 0.0337 |
| Propylene | NA |
| Isobutane | 0.0014 |
| Butane | 0.0031 |
| Isopentane | NA |
| Pentane | NA |

The average hydrocarbon composition from the gas chromatograms of FIGS. 9B and 10B is shown in TABLE 6.

TABLE 6
Average Gas Hydrocarbon Composition
(after operating the device)

| Compound | Percentage Composition (%) |
|---|---|
| Methane | 58.8814 |
| Ethane | 1.1940 |
| Ethylene | 0.5606 |
| Propane | 0.1676 |
| Propylene | 0.1169 |
| Isobutane | 0.0231 |
| Butane | 0.0336 |
| Isopentane | 0.0165 |
| Pentane | 0.0055 |

A mass balance using the data from Table 5 and Table 6 indicates a significant reduction in the measured hydrocarbon content with relatively small amounts of hydrocarbon propagation, e.g., formation of isopentane, pentane, etc. The mass balance, shown below in Table 7, indicates a significant conversion to non-hydrocarbon compounds that are likely hydrogen based on the carbon deposition observed on the electrode and dielectric insulator.

TABLE 7
Process Mass Balance

Mass Balance

| | | | | | | | | | |
|---|---|---|---|---|---|---|---|---|---|
| Feed Rate (SLPM N2) | 0.9825 | | | | | | | | |
| N2 Density (g/L) | 1.25 | | | | | | | | |
| Mass Flowrate (g/min) | 1.2281 | Ethane | Ethylene | Propane | Propylene | Isobutane | Butane | Isopentane | n-pentane |
| | Methane | | | | | | | | |
| Component Flowrate In | 1.1555 | 0.0167 | 0.0000 | 0.0004 | 0.0000 | 0.0000 | 0.0000 | 0.0000 | 0.0000 |
| (g/Min) | | | | | | | | | |
| Component Flowrate Out | 0.7231 | 0.0147 | 0.0069 | 0.0021 | 0.0014 | 0.0003 | 0.0004 | 0.0000 | 0.0000 |
| (g/Min) | | | | | | | | | |
| Component Total In | 1.1728 | | | | | | | | |
| (g/min) | | | | | | | | | |
| Component Total Out | 0.7491 | | | | | | | | |
| (g/min) | | | | | | | | | |
| Hydrogen (g/min) | 0.4236 | | | | | | | | |
| Hydrogen (%) | 36.12% | | | | | | | | |

This evaluation indicates approximately 36% of the mass fed into the reactor was converted to hydrogen, exiting with the gas stream, and carbon, such as elemental carbon, remaining within the reactor.

The data and observations described herein, show that a device having the configuration of the device 100 and performing the processes described herein can unexpectedly provide significant hydrocarbon destruction to generate carbon and hydrogen with relatively little hydrocarbon propagation. For example, the data and observations described herein provide a strong indication of methane destruction into the constituents of carbon and hydrogen. Further, the devices and processes described herein allow for hydrogen generation without coproduction of carbon dioxide.

### Additional Covalent Gases

It is believed that the embodiments described herein for the dissociation of hydrocarbons (for example, methane) into the basic elements of carbon and hydrogen can be extended to similar covalent gases. For example, it is theorized that the embodiments described herein can cause disassociation of carbon dioxide, CO2, into carbon and oxygen. It is theorized that the embodiments described herein can cause disassociation of hydrogen sulfide, H₂S, into sulfur and hydrogen.

Given the structural similarities between methane and hydrogen sulfide, as depicted below and the following bond energy comparison, the ability of the embodiments described herein to cause disassociation of hydrogen sulfide to sulfur and hydrogen is probable.

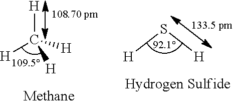

Structural differences between methane and carbon dioxide are more pronounced but could lend an increase in effectiveness due to a reduction in steric hinderance with the linear carbon dioxide structure.

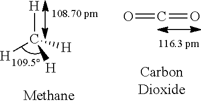

The dissociation observed with hydrocarbons, specifically methane, in the examples described herein demonstrates the ability of the embodiments described herein to disrupt the hydrogen-carbon bond, which has an associated bond energy of 440 KJ/mol. Given that the bond energy of the sulfur-hydrogen bond is 363 KJ/mol and the bond energy of the carbon-oxygen bond is 532 KJ/mol, it is predicted the same or similar dissociation mechanism will be observed when applying the embodiments described herein to carbon dioxide and hydrogen sulfide. In some embodiments, it is theorized that different input energies may be beneficial for disassociating the carbon-oxygen bond and the sulfur-hydrogen bond compared to the disassociation of the hydrogen-carbon bond. For example, dissociation of the sulfur-hydrogen may benefit from a lower energy input while dissociation of the carbon-oxygen may benefit from a slightly higher energy input.

To confirm the application of the embodiments described herein to carbon dioxide and hydrogen sulfide dissociation, experiments will be conducted using hydrogen sulfide as the feed gas and using carbon dioxide as the feed gas and manipulating independent variables of voltage, frequency, voltage gradient, wave form, and residence time. It is expected that these experiments will show disassociation of hydrogen sulfide into sulfur and hydrogen and carbon dioxide into carbon and oxygen.

The physical configuration arrangement and materials of construction may also be modified to evaluate any impacts.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

In the foregoing description, specific details are given to provide a thorough understanding of the examples. However, it will be understood by one of ordinary skill in the art that the examples may be practiced without these specific details.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A device for generating hydrogen, comprising:
a shell;
at least one grounded surface or electrode;
a fluid inlet in fluid communication with the shell;
a fluid outlet in fluid communication with the shell;
at least one dielectric insulator disposed with the shell in contact with the at least one grounded surface or electrode; and
at least one high voltage electrode disposed within the shell, the at least one high voltage electrode separated from the at least one dielectric insulator by a plasma zone.

2. The device of claim 1 wherein the at least one dielectric insulator is disposed within the shell such that it contacts the at least one grounded surface or electrode.

3. The device of claim 1, wherein the plasma zone is formed between the at least one high voltage electrode and the at least one dielectric insulator.

4. The device of claim 1, wherein the device further comprises a power supplier electrically connected to the at least one high voltage electrode, the power supplier configured to supply power to the at least one high voltage electrode in a form of an application voltage between 30,000 VAC and 50,000 VAC.

5. The device of claim 1, wherein the at least one grounded surface or electrode forms the shell.

6. The device of claim 1, wherein the at least one grounded surface or electrode is disposed on an inner surface of the shell.

7. The device of claim 1, wherein the at least one dielectric insulator is disposed on an inner surface of the at least one grounded surface or electrode.

8. The device of claim 1, wherein the at least one high voltage electrode is configured to generate a high voltage electric field within the plasma zone.

9. The device of claim 1, wherein the shell is cylindrical in shape.

10. The device of claim 9, wherein the at least one high voltage electrode and the at least one dielectric insulator are disposed concentrically or coaxially within the shell.

11. The device of claim 1, wherein the shell is a rectangular prism and wherein the at least one high voltage electrode is a plate electrode.

12. The device of claim 11, comprising a plurality of high voltage electrodes and a plurality of dielectric insulators arranged parallel to each other within the shell.

13. A method for generating hydrogen, comprising:
providing a feed fluid to a reaction vessel via a fluid inlet, wherein the reaction vessel comprises:
a shell;
a grounded electrode disposed proximate the shell;
a dielectric insulator in contact with the grounded electrode;
a high voltage electrode disposed in the shell such that the high voltage electrode is separated from the grounded electrode by a plasma zone of the reaction vessel; and
generating an electric field within the plasma zone of the reaction vessel;
disassociating components of the feed fluid due to the electric field; and
extracting one or more components of interest from the reaction vessel, via a fluid outlet of the reaction vessel.

14. The method of claim 13, wherein generating an electric field comprises supplying power to the high voltage electrode, wherein the power supplied is in a form of an application voltage between 30,000 VAC and 50,000 VAC.

15. The method of claim 14, wherein supplying power to the high voltage electrode is accomplished via a power supplier connected electrically to the high voltage electrode.

16. The method of claim 16, further comprising adjusting a retention time of the feed fluid within the reaction vessel such that feed fluid remains in the reaction vessel for between 30 seconds and 5 minutes.

17. The method of claim 13, wherein the feed fluid is compressed natural gas (CNG).

18. The method of claim 13, wherein the feed fluid comprises hydrocarbon components, and wherein disassociating the components of the feed fluid comprises disassociating the hydrocarbon components into hydrogen and carbon.

19. The method of claim 19, wherein extracting the component of interest comprises extracting hydrogen from the reaction vessel.

20. The method of claim 13, wherein the feed fluid does not comprise oxygen.
